(19) United States
(12) Patent Application Publication
(10) Pub. No.: US 2008/0035442 A1
(43) Pub. Date: Feb. 14, 2008

(54) ENERGY-ABSORBING PADDING WITH STAGED ELEMENTS

(76) Inventors: Gregory Spingler, St Amand les Eaux (FR); Luc Dornier, Seclin (FR)

Correspondence Address: VISTEON, C/O BRINKS HOFER GILSON & LIONE, PO BOX 10395, CHICAGO, IL, 60610, US

(21) Appl. No.: 11/874,675

(22) Filed: Oct. 18, 2007

Related U.S. Application Data
(63) Continuation of application No. 10/828,804, filed on Apr. 20, 2004.

(51) Int. Cl. B60R 21/04; F16F 7/12

(52) U.S. Cl. 188/377

(57) ABSTRACT

An energy-absorbing padding includes multiple stacked base layers, each of which includes a plurality of projecting, hollow, hemispherical or dome-shaped impact-absorbing elements defining respective convex impact surfaces. The elements of a first base layer, which either project in a direction opposite those of at least one other base layer or project in the same direction in a nested relationship, provide a staged response characteristic in which the first elements of a first base layer accommodate initial and off-axis occupant impacts, while the elements of the at least one other layers provide additional stiffness and energy absorption capability subsequent to at least a partial collapse of the first elements. The wall thickness of the elements may advantageously vary, for example, as a function of distance from the base layer, while a plurality of strengthening ribs may advantageously further serve to enhance the energy absorption capacity of the elements.

### CROSS-REFERENCE TO RELATED APPLICATION

This application is a continuation of U.S. patent application Ser. No. 10/828,804, filed Apr. 20, 2004, the entire contents of which are incorporated by reference.

### FIELD OF THE INVENTION

The invention relates to energy-absorbing passive safety devices for motor vehicle applications.

### BACKGROUND OF THE INVENTION

Motor vehicles are often provided with energy-absorbing dashboards and door panels that mitigate injury to vehicle passengers in the event of an accident. The prior art teaches a variety of energy-absorbing structures based on foams, honeycombs or injected parts that are designed to absorb the maximum part of the energy produced during a crash, and to control both the force level and the distance of crush.

Known designs often employ a plurality of molded frusto-conical or “truncated cone”-shaped energy-absorbing elements or modules projecting from one or both sides of a median plane, resulting in an initial peak of stress and a peak rate of loading that may exceed design objectives. One such known structure 100 featuring oppositely-projecting frusto-conical element, as taught in U.S. Pat. No. 6,550,850 and shown in FIG. 9, achieves a force-versus-displacement characteristic as illustrated by the solid-line plot 104 in FIG. 10, wherein the peak rate of stress generated upon contact of a vehicle occupant can be severe, and the initial stress may rapidly rise to ultimately peak at an undesirably high level. Also as seen in FIG. 10, which includes a broken-line plot 106 of the structure's force-versus-displacement characteristic for a 20° “off-axis” impact, the high initial stiffness and initial peak of stress of such structures are only partially mitigated, while the instantaneous stress achieved for a given crush continues to vary significantly, based upon the amount of crush and the impact angle, thereby further complicating the instantaneous loads experienced by the vehicle passenger on impact.

Accordingly, what is needed is an improved energy-absorbing padding that overcomes the aforesaid deficiencies of the prior art.

### SUMMARY OF THE INVENTION

According to one aspect of the invention, an energy-absorbing padding includes a plurality of hollow, hemispherical or dome-shaped elements integrally formed with each of at least two laminated base layers to thereby define a plurality of convex impact surfaces projecting from the base layers with which to progressively absorb an impact. Specifically, the hemispherical or dome-shaped elements respectively provide a convex contact or impact area on the padding which is a minimum at impact and progressively increases with the crush, thereby avoiding both a high initial stiffness and the initial peak of stress that is characteristic of the prior art, and providing improved occupant protection. Strengthening ribs, variations in element wall thickness, and modifications to the element's shape allow for the optimization of the initial rate of stress and relative stiffness of the elements over a range of crush. The energy-absorbing capacity of the padding is regulated by increasing or decreasing the number of elements, their size, their diameter, their thickness, and even the material used, for example, as selected from steel, aluminum, magnesium, polymers, and reinforced materials.

According to another aspect of the invention, the padding is divided into at least two levels or “stages” to provide a high quality of energy absorption even if the impact direction is not parallel to the main axis of the padding. Specifically, a first stage is adapted to provide initial energy absorption while avoiding an initial peak of stress, whereupon a second and, thereafter, perhaps even a third stage provides increased energy absorption capability with increasing padding crush. Preferably, the first stage further serves to redirect the direction of the loading to crush the second stage in the best way for energy absorption.

In a first embodiment, the first stage comprises relatively smaller elements projecting in a first direction from a first base layer, and the second stage comprises relatively larger elements projecting in a second, opposite direction from a second base layer that is bonded back-to-back with the first base layer. In other embodiments, the elements of at least one second stage are inserted or “nested” within the elements of the first stage, either concentrically or eccentrically, to similarly provide predictably-increasing stress with increased crush, while advantageously featuring a padding of relatively reduced overall thickness.

According to another aspect of the invention, the wall thickness and the size of the elements of one or more stages, the number of elements in each stage, and the relative positioning or location of the elements of each stage relative to those of the other stages, are selected to customize the manner in which the padding absorbs energy in a given application, particularly in the event of an “off-axis” impact. In nested embodiments, contiguous portions of the nested elements, for example, proximate to their respective bases, may advantageously be melded to provide additional stiffness, particularly in response to off-axis impacts.

From the foregoing, it will be appreciated that energy-absorbing padding according the invention advantageously provides a progressive impacted area with which to absorb applied energy in a smoother way for the vehicle occupant, thereby enhancing occupant safety, with a staged response further providing both a smooth progression in initial stress and a predictable post-peak stress that are relatively unaffected by off-axis impact angles of up perhaps 20° or greater.

Additional features, benefits, and advantages of the invention will become apparent to those skilled in the art to which the invention relates from the subsequent description of several exemplary embodiments and the appended claims, taken in conjunction with the accompanying Drawings.

### BRIEF DESCRIPTION OF THE DRAWINGS

In the Drawings, wherein the relative thickness of certain components has been increased for clarity of illustration:

FIG. 1 is an isometric view of the first exemplary multistage padding in accordance with the invention;

FIG. 2 is an elevation, partially broken away, of the first padding of FIG. 1, as supported by a relatively-stiff member;

FIG. 3 is a plot showing the force-versus-displacement characteristics of the first padding when subjected to both on-axis and off-axis impacts;

FIG. 4 is a sectional view of a second exemplary multistage padding in accordance with the invention, the opposing half being a mirror image thereof;

FIG. 5 is a plot showing the force-versus-displacement characteristics of the second heading when subjected to you on-axis impacts;

FIGS. 6-8 are sectional views of a third, fourth, and fifth exemplary multistage padding in accordance with the invention, the opposing halves being mirror images thereof;

FIG. 9 is a view in perspective of a known energy-absorbing structure featuring oppositely-projecting identically-shaped frusto-conical elements; and

FIG. 10 is a plot showing the force-versus-displacement characteristics of the known energy-absorbing structure of FIG. 9 when subjected to both on-axis and off-axis impacts.

### DETAILED DESCRIPTION OF THE PREFERRED EMBODIMENT

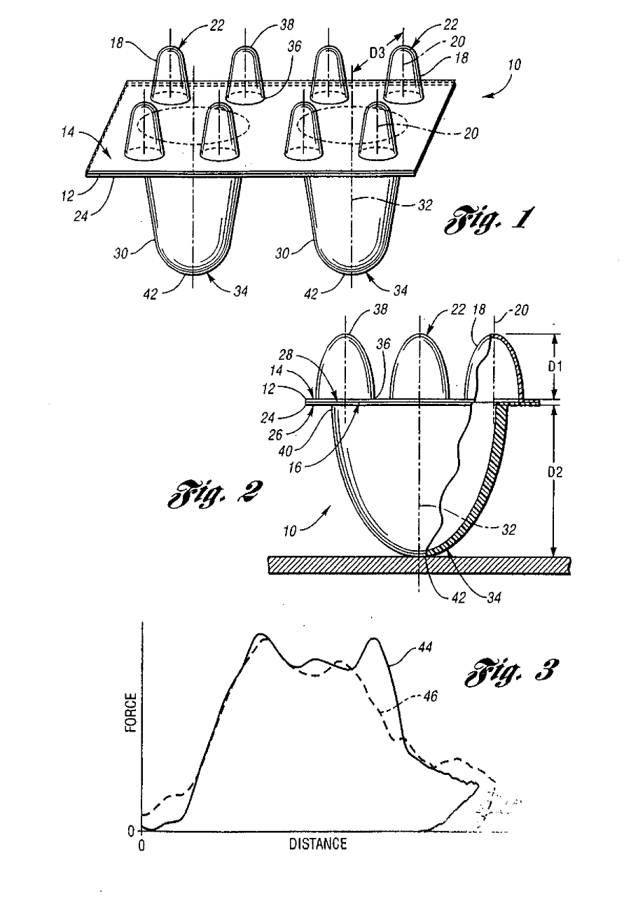

Referring to FIGS. 1 and 2, a first exemplary energy-absorbing padding 10 for a motor vehicle, for example, adapted to be installed within a vehicle door beneath a “skin” of interior trim (not shown), includes a first or upper base layer 12 having a first face 14, a second face 16, and a plurality of integrally-formed, hollow, first or upper elements 18 projecting from the upper base layer's first face 14 along a first axis 20 to thereby define convex impact surfaces 22 disposed a first distance D1 from the first face 14 of the upper base layer 12. The first padding 10 further includes a second or lower base layer 24 also including a first face 26, a second face 28, and a plurality of integrally-formed, hollow second or upper elements 30 projecting from the lower base layer's first face 26 along a second axis 32 to thereby define convex impact surfaces 34 on the lower layer 24 disposed a second distance D2 from the lower layer's first face 24. The second distance D2 is significantly greater than the first distance D1.

Also as seen in FIGS. 1 and 2, the upper base layer 12 is laminated with or affixed to the lower base layer 24 in any suitable manner, for example, by bonding the second face 16 of the first layer 12 to the opposed second face 28 of the lower layer 24. Thus, in the first padding 10, the upper and lower elements 18,30 respectively extend in opposite directions.

Referring to FIG. 2, the upper and lower elements 18,30 each have a domed or arch shape when viewed in cross-section. In accordance with another aspect of the invention, the relative wall thickness of each upper element 18 remains essentially constant from its base 36 to its convex peak 38, while the relative wall thickness of each lower element 30 becomes progressively less with increasing element height, i.e., when moving from its base 40 to its convex peak 42. The size, shape, wall thickness, and relative number and distribution, and materials choice (including, without limitation, steel, aluminum, magnesium, polymers, and reinforced materials) for upper elements 18 and the lower elements 30 are selected to provide the first padding 10 with a desired force-versus-displacement characteristic.

A plurality of ribs or grooves may also be advantageously formed into or around one or more the elements 18,30 to further tailor the padding's force-versus-displacement characteristic, for example, by regulating instantaneous element stiffness to achieve a near-constant level of stress over a significant range of crush, or a lower distance of crush. Moreover, if the lengths of the ribs or grooves, as measured from the element's base 36,40, are varied around the periphery of the base 36,40, the energy is absorbed not only with the straight crushing but also with the twisting of the element 18,30, thereby allowing for energy absorption into two kinematics, one translation and one rotation.

According to an aspect of the invention, the relatively-shorter upper elements 18 advantageously redirect off-axis impacts applied to their convex surfaces 22 onto the relatively-taller lower elements 30, thereby further improving the off-axis performance of the padding. To this end, the upper and lower elements 18,30 are laterally staggered, such that the major axis of a given upper element 18 is offset by a predetermined distance D3 from the major axis of a corresponding lower element 30. Similarly, as shown in FIGS. 1 and 2, several smaller upper elements 18 are advantageously grouped around, or otherwise operatively associated with, a given larger lower element 30, whereby impact loads applied to the upper elements 18 are suitably redirected onto the lower elements 30.

In use, the convex surfaces 22 of the upper dome-shaped elements 18 collectively define a progressive impact area on the padding 10 that is a minimum at impact and that increases with the crush. A smooth increase of force level with increasing crush is thereby achieved as the impact area of the padding 10 progressively increases during the crush, thereby avoiding both the very high stiffness in the beginning of the absorption process and the initial peak of stress, as illustrated in FIG. 3 by a solid-line plot 44 for “on-axis” impacts (those applied generally parallel to the major axes 20,32 of the elements 18,30), and by a broken-line plot 46 for a 20°-inclination “off-axis” impact. In contrast, in known energy-absorbing structures 100 such as the one illustrated in FIG. 9, the oppositely-projecting truncated cones 102 generate an initial peak of stress as shown in FIG. 10, whether the impact is “on-axis” as shown by the solid-line plot 104 of FIG. 10; or “off-axis” with the direction of impact is inclined by 20°, as shown by the broken-line plot 106 of FIG. 10.

FIG. 3 further illustrates that, once the stress has peaked, the first padding 10 continues to resist additional crush with a similar force for a significant amount of displacement and, further, that the amount of force for a given displacement remains similar without regard to whether the impact is on-axis or off-axis up to perhaps 20°. In contrast, both “on-axis” and “off-axis” plots 104,106 of FIG. 10 show that the truncated cones 102 of known energy-absorbing structures 100 provide a marked reduction in crush-resisting force and, hence, energy absorption, with increasing crush after the peak, and that the instantaneous post-peak stress varies greatly, depending upon impact angle.

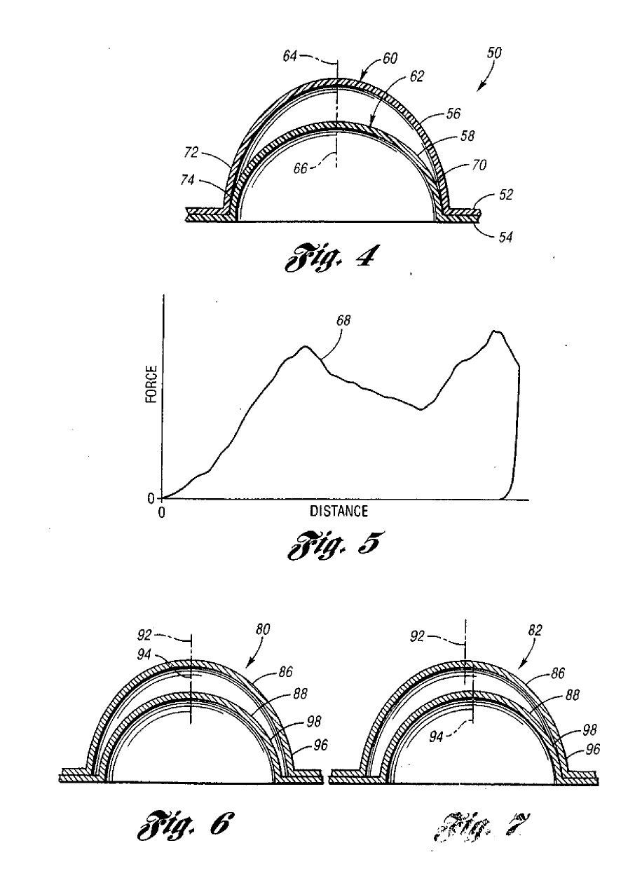

A second exemplary embodiment 50 of the energy-absorbing padding of the invention is shown in partial cross-section in FIG. 4. As in the first padding 10, the second padding 50 includes a pair of laminated base layers 52,54, each of which includes a plurality of projecting, hollow, hemispherical or dome-shaped elements 56,58 defining respective convex impact surfaces 60,62. In the second padding 50, however, the elements 58 of the lower layer 54 project. In the same direction as the elements 56 of the upper layer 52, along generally collinear axes 64,66 to thereby define a “nested” relationship in which the “lower” elements 58 project within the “upper” elements 56.

FIG. 5 illustrates the resulting force-versus-displacement plot 68 provided by the second padding 50, featuring a progressively-increasing stress with increased crush. As seen in FIG. 5, the second padding 20 advantageously provides a progressive impact area with which to absorb applied energy in a smoother way for the occupant and thus, the safety function of the padding is increased. Thus, the second padding 50 features an initial peak of stress that is substantially reduced relative to those demonstrated by known energy-absorbing structures. And, as in the first padding 10, the upper elements 56 of the second padding 50 advantageously operate to redirect off-axis impacts onto the corresponding, nested lower elements 58, thereby further improving “off-axis” impact performance.

Also as seen in FIG. 4, in accordance with another aspect of the invention, a peripheral portion 70 of the second padding's nested elements 56,58 are melded together in a suitable manner, proximate to their respective bases 72,74. In this manner, the lower (inner) element 58 serves to bolster both initial response provided by the upper (outer) element 56, and the padding's “off-axis” performance.

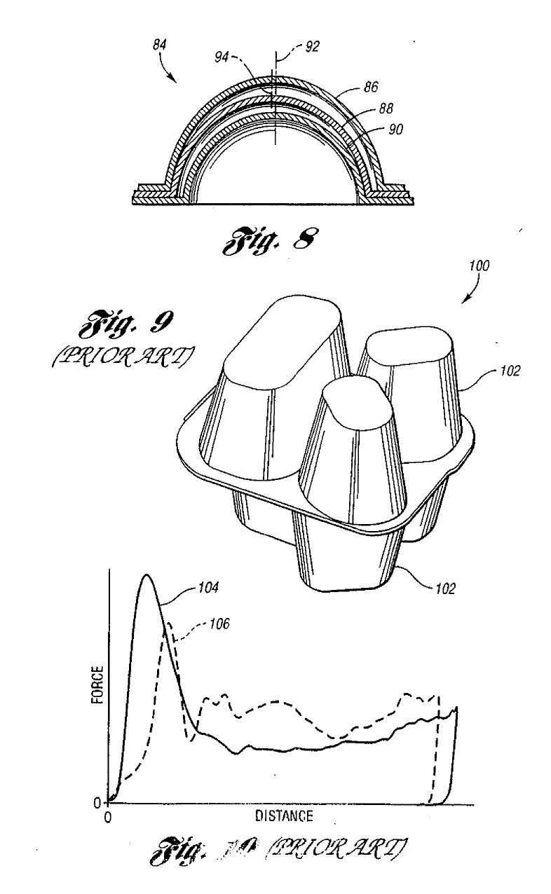

Referring to FIGS. 6-8, wherein like reference numerals are used to designate like components, a third, fourth, and fifth exemplary energy-absorbing padding 80,82,84 according to the invention features two or three nested stages of elements 86,88,90. Specifically, in the third padding 80, the axes 92,94 of the upper and lower elements 86,88 are generally collinear, but the respective bases 96,98 of the upper and lower elements 86,88 do not touch. In the fourth and fifth exemplary paddings 82,84, at least one nested lower element 88 is eccentrically positioned with respect to the upper element 86, with only a portion of the respective bases 96,98 being in touching contact and/or suitably affixed together. As in the first two exemplary paddings 10,50, the wall thickness, size, and number, and material of the nested elements 86,88,90 are selected to customize the manner in which the padding absorbs energy in a given application, particularly in the event of an “off axis” impact. And, as in the previous paddings 10,50, the first stage defined by the uppermost elements 86 preferably redirects the applied “off-axis” impact to crush the second stage, and any subsequent stage, in the best way for energy absorption.

While the above description constitutes the preferred embodiment, it will be appreciated that the invention is susceptible to modification, variation and change without departing from the proper scope and fair meaning of the subjoined claims.

What is claimed is:

1. An energy-absorbing padding for use in a motor vehicle comprises:
a first base layer having a planar first face, a planar second face, and a plurality of integrally-formed first elements projecting from the first face of the first base layer, each first element having an uninterrupted first surface of rotation defining an enclosed first hollow interior and having a first convex impact surface disposed a first distance from the first face of the first base layer;
a second base layer having a planar first face, a planar second face, and a plurality of integrally-formed second elements projecting from the first face of the second base layer, each second element having an uninterrupted second surface of rotation defining an enclosed second hollow interior and having a second convex impact surface disposed a second distance from the first face of the second base layer;
wherein the first base layer is laminated with the second base layer with the second face of the first base layer in opposition with a selected one of the group consisting of the first face of the second base layer and the second face of the second base layer, and the second distance is substantially different from the first distance.

2. The energy-absorbing padding of claim 1, wherein the first elements project from the first face of the first base layer in a first direction, and the second elements project from the first face of the second base layer in a second direction, the first direction being generally opposite the second direction.

3. The energy-absorbing padding of claim 2, wherein the first face of the second base layer is bonded to the second face of the second base layer.

4. The energy-absorbing padding of claim 1, wherein the first elements and second elements project in the same direction, and wherein the second face of the first base layer is placed in opposition with the first face of the second base layer.

5. The energy-absorbing padding of claim 4, wherein the second face of the first base layer is bonded to the first face of the second base layer.

6. The energy-observing padding of claim 5, wherein a peripheral portion of one first element proximate to the first face of the first base layer is affixed to a peripheral portion of one second element proximate to the first face of the second base layer.

7. The energy-absorbing padding of claim 1, wherein the first and second base layers are generally planar, and wherein each first element has a first major axis extending generally normal to the first base layer, and each second element has a second major axis extending generally normal to the second base layer.

8. The energy-absorbing padding of claim 7, wherein the first major axis of one first element is offset a predetermined distance from the second major axis of one second element.

9. The energy-absorbing padding of claim 7, wherein the first major axis of one first element is generally collinear with the second major axis of one second element.

10. The energy-absorbing padding of claim 1, wherein one of the first and second elements has a wall thickness that varies as a function of distance from the first face of the element's respective base layer.

11. The energy-absorbing padding of claim 1, wherein each first element defines in cross-section a portion of a sphere.

12. The energy-absorbing padding of claim 1, wherein each second element defines in cross-section a portion of an arch.

13. An energy-absorbing padding for use in a motor vehicle comprises:
a first base layer having a first face, a second face, and a plurality of integrally-formed, hollow, closed and dome-shaped, first elements defined by an uninterrupted first arch-shaped surface of rotation, the first elements projecting from the first face of the first base layer, each first element defining a convex impact surface disposed a first distance from the first face of the first base layer;
a second base layer having a first face, a second face, and a plurality of integrally-formed, hollow, closed and dome-shaped, second elements defined by an uninterrupted second arch-shaped surface of rotation, the second elements projecting from the first face of the second base layer, each second element defining a convex impact surface disposed a second distance from the first face of the second base layer,
wherein the first base layer is laminated with the second base layer with the second face of the first base layer in opposition with a selected one of the group consisting of the first face of the second base layer and the second face of the second base layer, and the second distance is substantially different from the first distance.

14. The energy-absorbing padding of claim 13, wherein the first elements and second elements project in the same direction, and wherein the second face of the first base layer is placed in opposition with the first face of the second base layer.

15. The energy-absorbing padding of claim 14, wherein the second face of the first base layer is bonded to the first face of the second base layer.

16. The energy-observing padding of claim 15, wherein a peripheral portion of one first element proximate to the first face of the first base layer is affixed to a peripheral portion of one second element proximate to the first face of the second base layer.

17. The energy-absorbing padding of claim 13, wherein the first and second base layers are generally planar, and wherein each first element has a first major axis extending generally normal to the first base layer, and each second element has a second major axis extending generally normal to the second base layer.

18. The energy-absorbing padding of claim 17, wherein the first major axis of one first element is generally collinear with the second major axis of one second element.

19. The energy-absorbing padding of claim 13, wherein each first element defines in cross-section a portion of a sphere.

20. The energy-absorbing padding of claim 13, wherein each second element defines in cross-section a portion of an arch.
